(19) United States
(12) Patent Application Publication
(10) Pub. No.: US 2026/0065899 A1
(43) Pub. Date: Mar. 5, 2026

(54) METHOD AND APPARATUS FOR EVALUATING SPEECH QUALITY

(71) Applicants: Hyundai Motor Company, Seoul (KR); Kia Corporation, Seoul (KR); UIF (University Industry Foundation), Yonsei University, Seoul (KR)

(72) Inventors: Sung Woong Hwang, Hwaseong-si (KR); Soo Joong Hwang, Hwaseong-si (KR); Chang Hwan Kim, Hwaseong-si (KR); Se Yun Um, Seoul (KR); Woo Seok Ko, Seoul (KR); Hong Goo Kang, Seoul (KR); Ju Hwan Yoon, Seoul (KR)

(21) Appl. No.: 19/314,809

(22) Filed: Aug. 29, 2025

(30) Foreign Application Priority Data
Aug. 30, 2024 (KR) 10-2024-0117406
Aug. 11, 2025 (KR) 10-2025-0110527

(51) Int. Cl. G10L 15/01; G10L 15/06

(52) U.S. Cl. CPC G10L 15/01; G10L 15/063; G10L 2015/0631

(57) ABSTRACT

In an embodiment a method for evaluating speech quality includes receiving, by a computing device, synthesized speech comprising one or more frames, determining, by the computing device, a latent representation corresponding to each frame, clustering, by the computing device, each latent representation and then mapping a center point of each cluster to an index to determine a centroid index sequence, determining, by the computing device, an embedding sequence by replacing each index of the centroid index sequence with an embedding corresponding to each index, and then masking one or more of embeddings, determining, by the computing device, a predicted index sequence that reconstructs a masked embedding based on a masked embedding sequence, and determining, by the computing device, an evaluation score based on a difference between the centroid index sequence and the predicted index sequence.

### CROSS-REFERENCE TO RELATED APPLICATIONS

This application claims the benefit of and priority to Korean Patent Application Nos. 10-2024-0117406, filed on Aug. 30, 2024 and 10-2025-0110527, filed on Aug. 11, 2025, the entire disclosures of which are hereby incorporated herein by reference in its entirety.

### TECHNICAL FIELD

The present disclosure relates to a method and apparatus for evaluating speech quality.

### BACKGROUND

The following description merely provides background information related to the present embodiment and does not constitute prior art.

The development goal of Text-To-Speech (TTS) is to generate synthesized speech that is similar to human speech, reflecting expressive variations such as emotion, prosody, and stress from input text.

Conventional quality evaluations of synthesized speech rely on subjective metrics such as the Mean Opinion Score (MOS). The MOS involves a plurality of evaluators listening to the same speech, individually assigning scores, and then calculating an average of the individual scores as the final score. While various studies are being conducted to develop objective evaluation methods, most studies focus on estimating speech quality using supervised learning of the MOS scores. However, supervised learning-based evaluation methods require large-scale speech-MOS pair datasets.

Anomaly detection is a technique that trains the distribution of normal data and then determines input data that deviates statistically significantly from the distribution as anomalies.

Unsupervised learning is a type of machine learning method that automatically trains similarities, cluster structures, or hidden patterns between input data without explicit labels for the input data.

### SUMMARY

Embodiments provide a computer-implemented method for evaluating speech quality, wherein the method comprises receiving synthesized speech including one or more frames, determining a latent representation corresponding to each frame, clustering each latent representation and then mapping a center point of each cluster to an index to determine a centroid index sequence, determining an embedding sequence by replacing each index of the centroid index sequence with an embedding corresponding to each index and then masking one or more of embeddings, determining a predicted index sequence that reconstructs a masked embedding based on a masked embedding sequence, and determining an evaluation score based on a difference between the centroid index sequence and the predicted index sequence.

Other embodiments provide an apparatus for evaluating speech quality, wherein the apparatus comprises at least one memory storing instructions and at least one processor, wherein the at least one processor executes the instructions to receive synthesized speech including one or more frames, determine a latent representation corresponding to each frame, cluster each latent representation and then map a center point of each cluster to an index to determine a centroid index sequence, determine an embedding sequence by replacing each index of the centroid index sequence with an embedding corresponding to each index and then mask one or more of embeddings, determine a predicted index sequence that reconstructs a masked embedding based on a masked embedding sequence, and determine an evaluation score based on a difference between the centroid index sequence and the predicted index sequence.

### BRIEF DESCRIPTION OF THE DRAWINGS

FIG. 1 is a block diagram schematically illustrating a configuration of an apparatus for evaluating speech quality according to one embodiment of the present disclosure;

FIG. 2 is a diagram illustrating a process in which an evaluation apparatus according to one embodiment of the present disclosure processes input speech;

FIG. 3 is a diagram illustrating a masking method according to one embodiment of the present disclosure;

FIG. 4A is a graph illustrating an evaluation of the quality of synthesized speech generated by a VITS model trained on a VCTK dataset, using the evaluation apparatus according to one embodiment of the present disclosure;

FIG. 4B is a graph illustrating an evaluation of the quality of synthesized speech generated by a VITS model trained on a LibriTTS dataset, using the evaluation apparatus according to one embodiment of the present disclosure;

FIG. 5 is a diagram illustrating a probability density function (PDF) based on a difference in a feature distribution between synthesized speech and referenced speech according to one embodiment of the present disclosure;

FIG. 6 is a schematic flowchart illustrating a method for diagnosing social anxiety disorder according to one embodiment of the present disclosure; and

FIG. 7 is a diagram schematically illustrating a configuration of an exemplary computing device that may be used to implement the apparatus and method described in the present disclosure.

### DETAILED DESCRIPTION OF ILLUSTRATIVE EMBODIMENTS

Embodiments provide a method and apparatus for evaluating speech quality. Specifically, embodiments provide a method and apparatus for objectively evaluating the quality of synthesized speech.

Embodiments achieved by the present disclosure are not limited to the embodiments mentioned above, and other embodiments not mentioned will be clearly understood by those skilled in the art from the description below.

Hereinafter, some embodiments of the present disclosure will be described in detail with reference to the accompanying drawings. In the following description, like reference numerals preferably designate like elements, although the elements are shown in different drawings. Further, the following description of some embodiments will omit for the purpose of clarity and for brevity, a detailed description of related known components and functions when considered to obscure the subject of the present disclosure.

Various ordinal numbers or alpha codes, such as first, second, i), ii), a), b), etc., are prefixed solely to differentiate one component from the other but not to imply or suggest the substances, order, or sequence of the components. Throughout this specification, when a part “includes' or ‘comprises’ a component, the part is meant to further include other components, to not exclude thereof unless specifically stated to the contrary.

The following detailed description, along with the accompanying drawings, is intended to illustrate exemplary embodiments of the present disclosure and is not intended to represent the only embodiments in which the disclosure may be practiced.

In the present disclosure, the term “synthesized speech” refers to speech data generated from a speech synthesis model such as TTS. The term “referenced speech” in the present disclosure refers to speech data recorded by an actual person. In the present disclosure, the term “input speech” refers to speech input into an AI-based model for training or inference purposes, and may be synthesized speech or referenced speech.

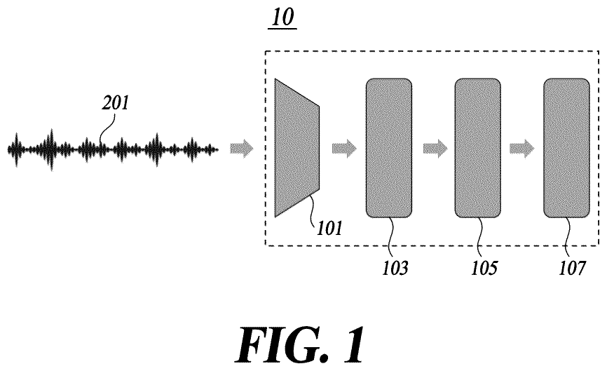

FIG. 1 is a block diagram schematically illustrating a configuration of an apparatus for evaluating speech quality according to one embodiment of the present disclosure. Not all blocks illustrated in FIG. 1 are essential components, and some blocks may be added, deleted, or modified in other embodiments. The components illustrated in FIG. 1 may be implemented as one or more software modules or components installed on one or more computing devices at one or more locations. In some implementations, one or more computing devices may be dedicated to a specific component.

Hereinafter, with reference to FIG. 1, an apparatus 10 (hereinafter, referred to as the “evaluation apparatus”) for evaluating speech quality according to one embodiment of the present disclosure will be described.

The evaluation apparatus 10 may be configured with an unsupervised learning-based machine learning model incorporating anomaly detection principles. The evaluation apparatus 10 may include one or more machine learning models. The machine learning model according to one embodiment of the present disclosure may be referred to as an artificial intelligence-based module or model, an artificial intelligence module or model, a computational model, a network function, a neural network, or the like.

The evaluation apparatus 10 may quantitatively evaluate how similar the synthesized speech is to the referenced speech. For example, the feature distribution of the referenced speech may be defined as normal, and the feature distribution of the synthesized speech may be defined as an anomaly. The evaluation apparatus 10 may be unsupervised-trained using the referenced speech. The evaluation apparatus 10 may evaluate the quality of the synthesized speech by quantitatively evaluating the extent to which the feature distribution of the synthesized speech deviates from the feature distribution of the trained referenced speech.

The evaluation apparatus 10 may include one or more of a feature extraction module 101, a discretization module 103, a distribution estimation module 105, and/or a score calculation module 107. The feature extraction module 101 may extract a latent representation for each frame from the input frame-by-frame speech using a pre-trained speech/audio model. The discretization module 103 may generate a centroid index sequence by applying clustering to each latent representation. The distribution estimation module 105 may be trained by masking the centroid index sequence and then predicting the masked index. The score calculation module 107 may calculate a loss value between the centroid index sequence and the predicted index sequence.

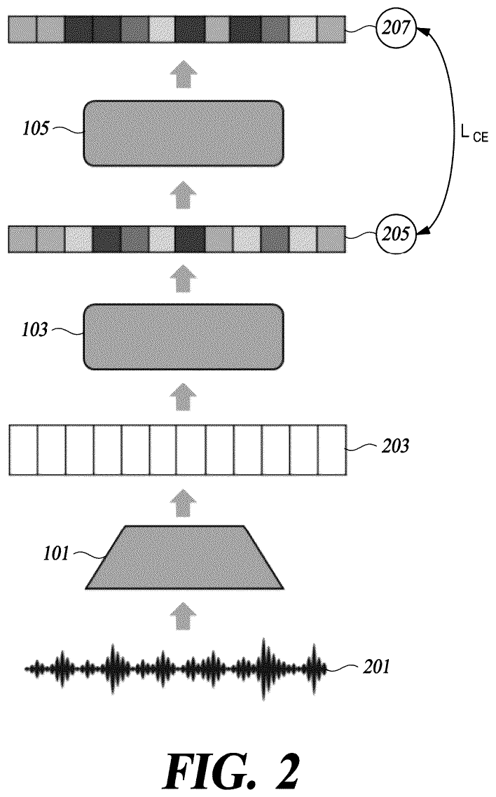

FIG. 2 is a diagram illustrating a process in which an evaluation apparatus according to one embodiment of the present disclosure processes the input speech.

Hereinafter, each element of the evaluation apparatus 10 according to one embodiment of the present disclosure will be described with reference to FIGS. 1 and 2.

The feature extraction module 101 may be configured with a pre-trained speech/audio model, such as a neural codec or a Self-Supervised Learning (SSL)-based model, to extract a latent representation 203 from input speech 201. When a machine learning-based model learns the latent representation 203, it has the advantage of being able to train features that richly express various types of information contained in the speech, such as a speaker, style, and contents. The latent representation may be referred to as a latent feature, feature vector, or hidden vector.

The feature extraction module 101 may be configured with a pre-trained WavLM model based on a transformer encoder. The WavLM model is a model that trains various speech features using the SSL method. The WavLM model uses a convolutional encoder based on a convolutional neural network (CNN) to convert frame-level input speech into the feature vector. The WavLM model applies self-supervised learning in a method of randomly masking some of the converted feature vectors, inputting masked feature vectors to the transformer encoder, and training to predict the masked feature vectors, thereby minimizing a loss between the feature vector and the masked feature vector.

The transformer encoder of the WavLM model consists of multiple layers, and each layer is trained to extract different features. For example, 6th and 23rd layers of the transformer layer are known to contain acoustic information and linguistic information, respectively. The feature extraction module 101 may obtain a latent representation in which acoustic and linguistic features are separated from the input speech by using the outputs of the 6th and 23rd layers of the transformer encoder. Thus, the evaluation apparatus 10 may evaluate the quality of multidimensional speech based on multiple dimensions of speech representation.

The discretization module 103 may generate a discrete embedding 205 by quantizing a continuous latent representation 203 by applying a clustering algorithm, such as a k-means clustering algorithm. The discrete embedding 205 according to one embodiment of the present disclosure may be referred to as a centroid index sequence. For example, the discretization module 103 may discretize the latent representation 203 into 1024 clusters and map each center point of the latent representation to an index. The number of clusters may be set by considering a balance between information loss that may occur during the quantization process and computational efficiency.

The distribution estimation module 105 may train the feature distribution of the input speech by receiving the centroid index sequence 205 as input. There are several advantages when the centroid index sequence 205 is used for training instead of the embedding itself. For example, the learning efficiency of the distribution estimation module 105 can be improved by reducing the number of model parameters and memory requirements. The distribution estimation module 105 may efficiently train a categorical variable or sparse data. The evaluation apparatus 10 enables quality evaluation directly related to a specific type of feature, such as the acoustic or linguistic features of the synthesized speech.

The distribution estimation module 105 may train the feature distribution of input speech. The distribution estimation module 105 may be configured as a neural network based on a transformer encoder.

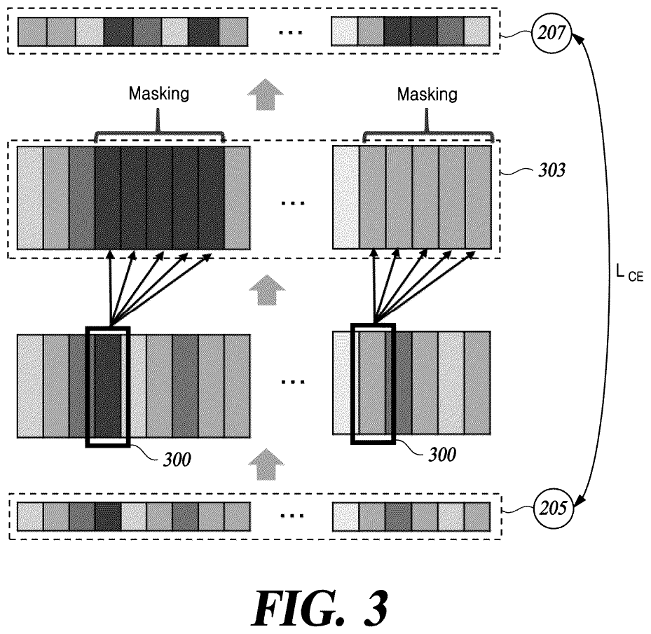

FIG. 3 is a drawing for explaining a masking method according to one embodiment of the present disclosure.

Referring to FIG. 3, the distribution estimation module 105 may mask a specific time section of the centroid index sequence 205. For example, the distribution estimation module 105 may generate an embedding sequence by replacing each index of the centroid index sequence 205 with an embedding corresponding to the index. The distribution estimation module 105 may perform the masking by randomly selecting one embedding 300 of the embedding sequence and replacing five consecutive embeddings from the selected embedding with the selected embedding. The masking method according to one embodiment of the present disclosure has the advantage of leaving more information in speech data compared to a method of filling the masking with 0 or randomly masking.

The distribution estimation module 105 may be trained to receive a masked embedding sequence 303 as input and estimate a predicted index sequence 207 that reconstructs the masked index embedding. For example, the distribution estimation module 105 may estimate the predicted index sequence 207, the score calculation module 107 may calculate a cross-entropy loss between the predicted index sequence 207 and the centroid index sequence 205, and the parameter of the distribution estimation module 105 may be iteratively updated using a backpropagation algorithm based on a cross-entropy loss function. Accordingly, the distribution estimation module 105 may train the feature distribution of the referenced speech by iteratively performing predictions that restore the masked index.

The distribution estimation module 105 may be configured as a neural network based on a transformer encoder to train the feature distribution of referenced speech and estimate the centroid index sequence 205 of the synthesized speech.

The inference of the distribution estimation module 105 may be applied with the same masking method as in the training. For example, the distribution estimation module 105 may receive the masked embedding sequence 303 as input and estimate a predicted index sequence that reconstructs the masked embedding in the same manner as in the training. The score calculation module 107 may calculate the evaluation score based on the cross-entropy loss value between the predicted index sequence 207 and the centroid index sequence 205. For example, the loss value may be the evaluation score. When the evaluation score of the evaluation apparatus 10 is calculated based on the cross-entropy loss, a higher score may be interpreted as the more similar the synthesized speech is to the referenced speech.

The score calculation module 107 may calculate a cross entropy (CE) loss between a predicted index 207 distribution and a centroid index 205 of the input speech. A cross-entropy loss function L_{CE} is as illustrated in Mathematical Expression 1.

$${L}_{CE} = - {\sum }_{i = 1}^{n} q ( {x}_{i} ) log p ( {\hat{x}}_{i} ) \qquad [ Mathematicl Expression 1 ]$$

xᵢ represents the centroid index 205 of the input speech, and &; represents the predicted index 207 of the input speech. q(xᵢ) and p(\hat{x}ᵢ) represent the probability of the i-th index of the input speech and the predicted probability distribution for the i-th index.

When the feature distributions of the synthesized speech and the referenced speech are similar, the distribution estimation module 105 illustrates a low loss value because it is trained with the referenced speech. When the feature distribution of the synthesized speech deviates significantly from the feature distribution of the referenced speech, the loss value is a high loss value. That is, the distribution estimation module 105 perform the training by considering the feature distribution of the referenced speech as normal, defining the feature distribution of the synthesized speech as an anomaly, comparing the feature distribution of the synthesized speech with the feature distribution of the referenced speech, and adjusting the loss value depending on the presence or absence of an anomaly.

In the inference process of the evaluation apparatus 10, a quality score may be calculated based on the loss value. For example, loss values output from each layer of the WavLM transformer encoder may be combined with the same weight and integrated into the final evaluation score. The distribution estimation module 105 may be trained separately depending on which layer's output is input. That is, a separate learning and inference model may be implemented depending on the features of the speech. Accordingly, the evaluation apparatus 10 may obtain multiple sets of scores representing various aspects of quality, such as naturalness of the input speech, speaker similarity, and intelligibility. That is, by integrating a plurality of evaluation scores determined based on latent representations corresponding to different acoustic features, the integrated score that evaluates the multidimensional speech quality may be calculated.

Hereinafter, a method for measuring the evaluation performance of the evaluation apparatus 10 according to one embodiment of the present disclosure will be described.

Table 1 summarizes a description of training data and evaluation data of the evaluation apparatus 10 according to one embodiment of the present disclosure.

TABLE 1

| | Evaluation Data | |
|---|---|---|
| Training Data | Step-wise evaluation | model-wise evaluation |
| 42 hours of VCTK | To evaluate synthesized | To compare speech |
| 225 hours of | speech of various quality | quality between different |
| LibriTTS | levels | TTS models |
| All downs-sampled | Synthesized speech is | Model used: |
| to 16 kHz | generated three times for | FastSpeech2, VITS |
| | each learning stage | |
| | (initial, intermediate, and | |
| | full) | |
| | Model used: VITS | |
| | Datasets: VCTK and | |
| | LibriTTS | |

The VCTK dataset is a high-quality English speech dataset provided by the University of Edinburgh in Scotland. The VCTK dataset contains speech data recorded by over 100 speakers across a variety of dialects and accents. The LibriTTS dataset is a large-scale speech dataset for TTS that is extended based on LibriSpeech. In the LibriTTS dataset, since the speech and sentence text of multiple speakers are aligned, the LibriTTS dataset may be used to analyze the quality of synthesized speech and secure diversity in sound/linguistic expression. The variational Inference Text-to-Speech (VITS) is an end-to-end speech synthesis model that integrates a variational autoencoder (VAEs), adversarial training (GAN), and normalizing flow techniques, capable of generating natural-sounding speech from input text. The FastSpeech2 is a TTS model that may rapidly generate speech from text by predicting auxiliary features such as phoneme duration, pitch, loudness, and intensity.

Table 2 summarizes the results of evaluating the quality of the evaluation data.

TABLE 2

| Dataset | Training Stage | WER↓ | NISQA-TTS↑ |
|---|---|---|---|
| VCTK | Early | 67.36% | 2.984 |
| | Intermediate | 40.57% | 3.544 |
| | Full | 22.70% | 4.042 |
| | Ground-Truth | 11.66% | 3.768 |
| LibriTTS | Early | 31.87% | 3.087 |
| | Intermediate | 20.03% | 3.392 |
| | Full | 14.67% | 3.541 |
| | Ground-Truth | 5.79% | 3.811 |

The Word Error Rate (WER) is an indicator that evaluates the accuracy between the speech recognition result and the actual label sentence. The WER has a direct correlation with the linguistic clarity of the speech, and the lower the WER, the higher the linguistic clarity. Neural Intrusive Speech Quality Assessment for TTS (NISQA-TTS) is a neural network-based quality evaluation model developed to automatically predict the quality of synthesized speech. The NISQA-TTS is trained with the Mean Opinion Score (MOS) dataset and calculates a score that comprehensively reflects various quality factors such as naturalness, intelligibility, noise, and distortion. The higher the NISQA-TTS, the higher the speech quality is considered.

Referring to Table 1, to obtain synthesized speech of various qualities, synthesized speech samples are generated three times for each learning stage (initial, intermediate, and full) of the VITS model. Referring to Table 2, as the learning stage progresses, the WER score decreases and the NISQA-TTS score tends to increase. This confirms that the quality of the synthesized speech is improving. As the quality of the synthesized speech samples improves, the performance of the evaluation apparatus 10 can be fairly analyzed.

Referring to Table 1, the model-specific evaluation method generates synthesized speech samples using the FastSpeech2 and VITS model. Thus, the evaluation apparatus 10 may compare the qualities of synthesized speech samples generated by different TTS models.

Table 3 is an example of an architecture of an evaluation apparatus 10 according to one embodiment of the present disclosure.

TABLE 3

| | |
|---|---|
| Base model of feature extraction | WavLM |
| module | |
| Number of transformer encoder | 24 layers |
| layers in feature extraction | |
| module | |
| Selected layer of transformer | 6th layer (for extracting acoustic |
| encoder layers in feature | information) |
| extraction module | 23rd layer (for extracting linguistic |
| | information) |
| Number of feature embeddings | 1 set per selected layer (2 sets total) |
| Clustering method | k-means |
| Number of clusters | 1024 |
| Structure of distribution | 6 transformer encoder layers |
| estimation module | |
| Number of attention heads in | 8 per layer |
| distribution estimation module | |
| Number of distribution | 1 per selected layer, trained separately |
| estimation modules | (2 total) |

For example, referring to Table 3, the feature extraction module 101 may be implemented as a pre-trained WavLM Large model based on a transformer encoder. The feature extraction module 101 may be implemented with the 6th layer and the 23rd layer to extract the acoustic information and language information. Accordingly, two types of latent representations may be extracted from one input speech. The two types of latent representations may be input to separate distribution estimation modules 105, respectively. The distribution estimation module 105 may be implemented with six layers of a transformer encoder. Each layer may have eight attention heads.

Hereinafter, the evaluation results for each learning stage of the evaluation apparatus 10 according to one embodiment of the present disclosure will be described.

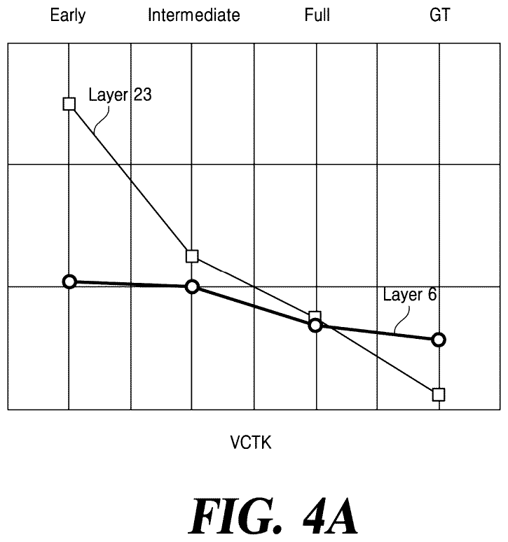

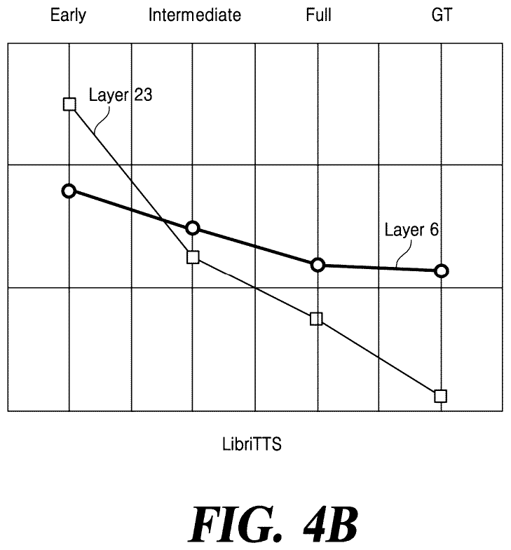

FIG. 4A is a graph illustrating an evaluation of the quality of synthesized speech generated by a VITS model trained on the VCTK dataset, using the evaluation apparatus according to one embodiment of the present disclosure.

FIG. 4B is a graph illustrating an evaluation of the quality of synthesized speech generated by the VITS model trained on the LibriTTS dataset, using the evaluation apparatus according to one embodiment of the present disclosure.

Referring to FIGS. 4A and 4B, both FIGS. 4A and 4B visualize the evaluation score by classifying the evaluation score according to the selected layer. As the VITS model's training phase progresses, the evaluation scores for the quality of the synthesized speech consistently approach a ground truth (GT). While the absolute scores may vary depending on the recording environment across datasets, the score trend is maintained.

Referring to FIGS. 4A and 4B, it can be confirmed that the evaluation scores differ depending on the layer. Since the transformer of the WavLM model contains different information for each layer, the evaluation apparatus 10 may obtain multiple sets of scores representing various aspects of quality.

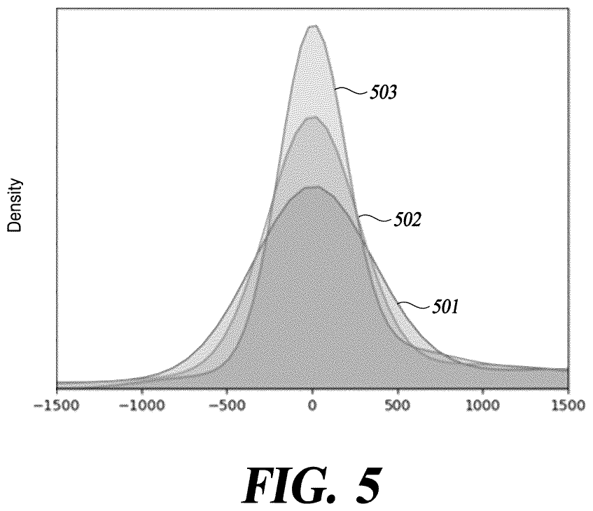

FIG. 5 is a diagram illustrating a probability density function (PDF) according to the difference in feature distribution between the synthesized speech and referenced speech according to one embodiment of the present disclosure.

Referring to FIG. 5, the x-axis represents the difference in distribution between the referenced speech and the synthesized speech. The closer the difference is to 0, the more similar the distributions of the referenced speech and the synthesized speech are. The y-axis represents the probability density of the difference value. The probability density indicates how frequently a specific difference value occurs.

Referring to FIG. 5, as the VITS model progresses from the early (501) stage to the intermediate (502) and full (503) stages, the distribution gap narrows and becomes more concentrated in the center. This suggests that the quality of the synthesized speech improves as the learning stage progresses.

Hereinafter, the evaluation results for each model of the evaluation apparatus 10 according to one embodiment of the present disclosure will be described.

Table 4 summarizes the model-specific evaluation results for the referenced speech and two types of synthesized speech.

TABLE 4

| | | | | | Evaluation score of | | |
|---|---|---|---|---|---|---|---|
| | | | | | evaluation apparatus 10↓ | | |
| | | | NISQA- | | Layer | Layer | |
| Dataset | Type | MOS↑ | TTS↑ | WER↓ | 6 | 23 | Combined |
| VCTK | FastSpeech2 | 3.00 | 3.127 | 16.78% | 0.9433 | 0.9158 | 0.9295 |
| | | (±0.14) | | | | | |
| | VITS | 4.58 | 4.402 | 22.70% | 0.9188 | 0.9221 | 0.9204 |
| | | (±0.10) | | | | | |
| | Ground | 4.74 | 3.768 | 11.66% | 0.9096 | 0.8813 | 0.8954 |
| | Truth (Seen | (±0.09) | | | | | |
| | spk) | | | | | | |
| | Ground | | | | 0.9314 | 0.8958 | 0.9136 |
| | Truth | | | | | | |
| | (Unseen | | | | | | |
| | spk) | | | | | | |
| LibriTTS | FastSpeech2 | 2.61 | 2.895 | 11.25% | 1.0535 | 0.9668 | 1.0102 |
| | | (±0.13) | | | | | |
| | VITS | 3.69 | 3.541 | 14.67% | 1.0260 | 0.9747 | 1.0003 |
| | | (±0.15) | | | | | |
| | Ground | 4.24 | 3.811 | 5.79% | 0.9964 | 0.9348 | 0.9656 |
| | Truth (Seen | (±0.15) | | | | | |
| | spk) | | | | | | |
| | Ground | | | | 1.0750 | 0.9507 | 1.0128 |
| | Truth | | | | | | |
| | (Unseen | | | | | | |
| | spk) | | | | | | |

Referring to Table 4, MOS evaluations were collected from a total of 19 participants. The evaluation scores of the evaluation apparatus 10 were given equal weights of 0.5 for the 6th and 23rd layers, respectively. The evaluation scores of the evaluation apparatus 10 consistently show a high correlation with the actual perceived quality (GT) for all datasets.

Table 5 is a table illustrating the correlation between the evaluation score of the evaluation apparatus 10 and the MOS evaluation.

TABLE 5

| | Pearson correlation coefficient ↑ |
|---|---|
| NISQA-TTS | 0.465 |
| WER | 0.224 |
| Layer 6 score | 0.522 |
| Layer 23 score | 0.451 |
| Integrated evaluation score | 0.489 |
| (Layer 6 + Layer 23) | |

Referring to Table 5, the correlation between the evaluation score of the evaluation apparatus 10 and the MOS evaluation may be confirmed. Table 5 utilizes the absolute value of the Pearson correlation coefficient, which has a value between 0 and 1. 0 means no correlation, and 1 means a perfect linear relationship. Referring to Table 5, it can be confirmed that the evaluation score of the evaluation apparatus 10 has a correlation that is at least 5% higher than that of the NISQA-TTS, which is designed to predict the MOS score.

The evaluation apparatus 10 may capture naturalness and intelligibility from the input speech, respectively. For example, referring to Table 4, the MOS score for LibriTTS-FastSpeech2 data was relatively low at 2.61, but the MOS score for WER was estimated to be at a good level at 11.25%. Comparing LibriTTS-FastSpeech2 data and LibriTTS-VITS data, LibriTTS-FS2 data may be relatively unnatural or mixed with noise, but is interpreted as being clearer. This subtle difference in evaluation is also accurately reflected in the evaluation score of the evaluation apparatus 10. The 6th layer score was higher for LibriTTS-FastSpeech2 than for LibriTTS-VITS, and the 23rd layer score was higher for LibriTTS-VITS than for LibriTTS-FastSpeech2. Since the output of the 6th layer includes the acoustic information and the output of the 23rd layer includes linguistic information, it can be confirmed that the evaluation score of the evaluation apparatus 10 is effective in multidimensionally evaluating speech quality within one system.

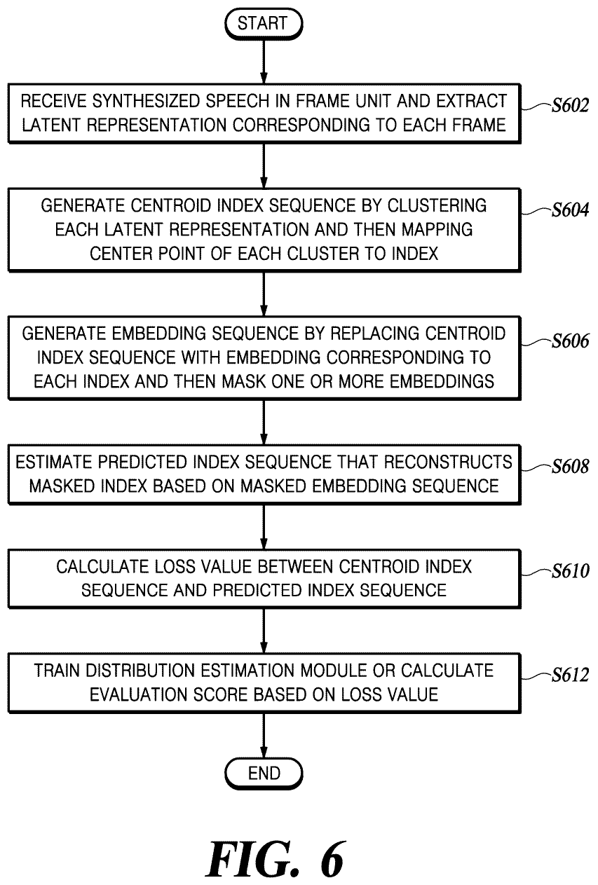

FIG. 6 is a schematic flowchart illustrating a method for evaluating speech quality according to one embodiment of the present disclosure. Hereinafter, a method for evaluating the speech quality will be described.

To evaluate the quality of synthesized speech or to train referenced speech, the evaluation apparatus 10 may receive input speech. The feature extraction module 101 may receive the input speech in frame units and extract latent representations corresponding to each frame (S602). To extract the latent representations, the feature extraction module 101 may be configured with a pre-trained WavLM model based on the transformer encoder.

The discretization module 103 may generate the centroid index sequence by clustering each latent representation using a clustering algorithm such as the k-means clustering algorithm and then mapping the center point of each cluster to an index (S604).

The distribution estimation module 105 may be configured as a machine learning model for training the feature distribution of referenced speech using an unsupervised learning method. Alternatively, the distribution estimation module 105 may be configured as the machine learning model for inferring the feature distribution of synthesized speech using the unsupervised learning method.

The distribution estimation module 105 may generate the embedding sequence by replacing the centroid index sequence 205 with an embedding corresponding to each index. The distribution estimation module 105 may mask the embedding 300 of the embedding sequence (S606). The masking method may be performed by selecting an arbitrary embedding 300 of the embedding sequence 205 and replacing five consecutive embeddings starting from the selected embedding 300 with the selected embedding.

The distribution estimation module 105 may estimate the predicted index sequence 207 that reconstructs a masked index based on the masked embedding sequence 303 (S608).

The score calculation module 107 may calculate the cross-entropy loss between the centroid index sequence 205 and the predicted index sequence 207 (S610).

The distribution estimation module 105 may train the feature distribution of the referenced speech by repeatedly updating parameters using a backpropagation algorithm based on the cross-entropy loss function. Alternatively, the score calculation module 107 may calculate the evaluation score for the quality of the synthesized speech based on the loss value (S612).

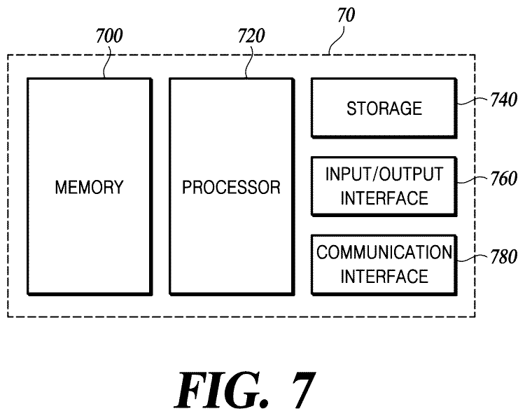

FIG. 7 is a diagram schematically illustrating the configuration of an exemplary computing device that may be used to implement the apparatus and method described in the present disclosure.

A computing device 70 may include some or all of a memory 700, a processor 720, storage 740, an input/output interface 760, and a communication interface 780. The computing device 70 may be a stationary computing device, such as a desktop computer or server, or a mobile computing device, such as a laptop computer or smartphone. The computing device 70 may include any specialized hardware accelerator capable of efficiently processing operations for an artificial intelligence model. For example, the computing device 70 may include a graphics processing unit (GPU), a tensor processing unit (TPU), or a neural processing unit (NPU).

The memory 700 may store a program that causes the processor 720 to perform methods or operations according to various embodiments of the present disclosure. For example, the program may include a plurality of instructions executable by the processor 720, and the aforementioned methods or operations may be performed by the execution of the plurality of instructions by the processor 720. The memory 700 may be a single memory or a plurality of memories. In this case, information required to perform the methods or operations according to various embodiments of the present disclosure may be stored in a single memory or divided and stored across multiple memories. When the memory 700 includes the plurality of memories, the plurality of memories may be physically separated. The memory 700 may include at least one of volatile memory and non-volatile memory. The volatile memory includes Static Random Access Memory (SRAM) or Dynamic Random Access Memory (DRAM), and the non-volatile memory includes flash memory.

The processor 720 may include at least one core capable of executing at least one instruction. The processor 720 may execute instructions stored in the memory 700. The processor 720 may be a single processor or a plurality of processors.

The storage 740 maintains stored data even when power to the computing device 70 is cut off. For example, the storage 740 may include non-volatile memory or a storage medium such as magnetic tape, an optical disk, or a magnetic disk. A program stored in storage 740 may be loaded into memory 700 before being executed by the processor 720. The storage 740 may store files written in a programming language, and programs generated from the files by a compiler or the like may be loaded into the memory 700. The storage 740 may store data to be processed by the processor 720 and/or data processed by the processor 720.

The input/output interface 760 may provide an interface with input devices, such as a keyboard or mouse, and/or output devices, such as a display device or printer. A speaker may trigger the execution of a program by the processor 720 through an input device and/or check the processing results of the processor 720 through an output device.

The communication interface 780 may provide access to an external network. The computing device 70 may communicate with other devices through the communication interface 780.

The components described in the exemplary embodiments of the present disclosure may be achieved by hardware components including at least one of Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the steps described in the exemplary embodiments of the present disclosure may be achieved by software that may be recorded on a recording medium. At least some of the components, functions, and steps described in the exemplary embodiments of the present disclosure may be achieved by a combination of hardware and software.

The method according to exemplary embodiments of the present disclosure may be written as a program that can be executed in a computer and may be implemented using various recording media, such as magnetic storage media, optical readout media, digital storage media, etc.

Implementations of the various techniques described herein may be implemented as digital electronic circuitry, or as computer hardware, firmware, software, or combinations thereof. Implementations may be implemented as computer program products, i.e., computer programs tangibly embodied in an information carrier, e.g., a machine-readable storage device (computer-readable medium), or a radio signal, for processing by, or controlling the operation of, a data processing device, e.g., a programmable processor, a computer, or a plurality of computers. A computer program, such as the computer program(s) described above, may be written in any form of programming language, including compiled or interpreted languages and may be deployed in any form, including as a stand-alone program or as modules, components, subroutines, or other units suitable for use in a computing environment. The computer program may be deployed to be processed on a computer or computers at a single site, or distributed across multiple sites and interconnected by a communication network.

Processors suitable for processing computer programs include, for example, both general-purpose and special-purpose microprocessors, and any one or more processors of any type of digital computer. Generally, the processor will receive instructions and data from read-only memory or random access memory, or both. Elements of the computer may include at least one processor executing instructions and one or more memory devices storing instructions and data. In general, the computer may include one or more mass storage devices, such as magnetic, magneto-optical, or optical disks, that store data, or may be coupled to receive data from them, transmit data to them, or both. Information carriers suitable for embodying computer program instructions and data include, for example, semiconductor memory devices, e.g., hard disks, magnetic media such as floppy disks and magnetic tapes, optical media such as compact disk read only memory (CD-ROM) and digital video disks (DVDs), magneto-optical media such as floptical disks, read only memory (ROM), random access memory (RAM), flash memory, erasable programmable ROM (EPROM), electrically erasable programmable ROM (EEPROM), and the like. The processor and memory may be supplemented by or include special-purpose logic circuitry.

The processor may perform an operating system and software applications executed on the operating system. The processor device may also access, store, manipulate, process, and generate data in response to the execution of the software. For ease of understanding, a processor device is sometimes described as utilizing a single processing element, but one of ordinary skill in the art will recognize that a processor device may include a plurality of processing elements and/or a plurality of types of processing elements. For example, a processor device may include a plurality of processors or one processor and one controller. Other processing configurations, such as a parallel processor, can be used.

Further, the non-transitory computer-readable media may be any available medium that can be accessed by a computer and may include both computer storage media and transmission media.

While this specification includes details of some specific implementations, they should not be understood as limiting the scope of any invention or claimed subject matter, but rather as a description of features that may be peculiar to a particular embodiment of a particular invention. Certain features described herein in the context of individual embodiments may be implemented in combination in a single embodiment. Conversely, various features described in the context of a single embodiment may also be implemented in a plurality of embodiments, either individually or in any suitable sub-combination. Further, while features may operate in a particular combination and be initially described literally as claimed, one or more features of the claimed combination may be excluded from the claimed combination in some instances, and the claimed combination may be changed to a sub-combination or variation of the sub-combination.

Similarly, although the drawings depict operations in a particular order, it should not be understood that such operations must be performed in the particular or sequential order depicted or that all depicted operations must be performed to achieve a desired result. In certain cases, multitasking and parallel processing may be advantageous. Further, the separation of the various device components in the embodiments described above should not be understood to require such separation in all embodiments, and it should be understood that the program components and devices described may generally be integrated into a single software product or packaged in multiple software products.

According to at least one embodiment of the present disclosure, it is possible to provide the method and apparatus capable of multidimensionally evaluating the quality of synthesized speech.

The effects of the present disclosure are not limited to those mentioned above, and other effects not mentioned will be clearly understood by those skilled in the art from the following description.

On the other hand, the embodiments of the present disclosure presented by the specification and drawings are merely specific examples for clarity and are not intended to limit the scope of the disclosure. It should be clear to those of ordinary skill in the art that, besides the embodiments disclosed herein, modifications thereto can be made within the scope of the present disclosure.

The scope of protection of the present disclosure is to be construed by the following claims, and all equivalent technical ideas within the scope thereof are to be construed as being included in the scope of the present disclosure.

What is claimed is:

1. A method for evaluating speech quality, the method comprising:
receiving, by a computing device, synthesized speech comprising one or more frames;
determining, by the computing device, a latent representation corresponding to each frame;
clustering, by the computing device, each latent representation and then mapping a center point of each cluster to an index to determine a centroid index sequence;
determining, by the computing device, an embedding sequence by replacing each index of the centroid index sequence with an embedding corresponding to each index, and then masking one or more of embeddings;
determining, by the computing device, a predicted index sequence that reconstructs a masked embedding based on a masked embedding sequence; and
determining, by the computing device, an evaluation score based on a difference between the centroid index sequence and the predicted index sequence.

2. The method of claim 1, wherein the latent representation is extracted using a machine learning model that has pre-trained referenced speech using a self-supervised learning method.

3. The method of claim 1, wherein clustering uses a k-means clustering algorithm.

4. The method of claim 1, wherein masking is performed by randomly selecting one embedding from the embedding sequences and replacing five consecutive embeddings starting from the selected embedding with the one embedding.

5. The method of claim 1, wherein the predicted index sequence is estimated using a machine learning model that has pre-trained a feature distribution of referenced speech using an unsupervised learning method.

6. The method of claim 1, wherein determining the evaluation score comprises determining a loss value between the centroid index sequence and the predicted index sequence using a cross-entropy loss function.

7. The method of claim 1, further comprising determining an integrated score that evaluates multidimensional speech quality by integrating a plurality of evaluation scores determined based on latent representations corresponding to different acoustic features.

8. The method of claim 1, wherein determining the latent representation corresponding to each frame comprises extracting acoustic information from a sixth layer and linguistic information from a twenty-third layer of a transformer encoder.

9. The method of claim 1, wherein clustering each latent representation comprises discretizing the latent representation into 1024 clusters.

10. A method for training a speech quality evaluation method, the method comprising:
receiving, by a computing device, referenced speech comprising one or more frames;
determining, by the computing device, a latent representation corresponding to each frame;
clustering, by the computing device, each latent representation, and then mapping a center point of each cluster to an index to determine a centroid index sequence;
determining, by the computing device, an embedding sequence by replacing each index of the centroid index sequence with an embedding corresponding to each index, and then masking one or more of the embeddings;
determining, by the computing device, a predicted index sequence that reconstructs a masked embedding based on a masked embedding sequence, using a machine learning model that has pre-trained a feature distribution of the referenced speech using an unsupervised learning method;
determining, by the computing device, a loss value between the centroid index sequence and the predicted index sequence; and
updating, by the computing device, a parameter of the machine learning model based on the loss value.

11. An apparatus comprising:
one or more processors; and
at least one memory storing a program including program instructions that, when executed by the one or more processors, cause the one or more processors to perform operations comprising:
receiving synthesized speech comprising one or more frames;
determining a latent representation corresponding to each frame;
clustering each latent representation, and then mapping a center point of each cluster to an index to determine a centroid index sequence;
determining an embedding sequence by replacing each index of the centroid index sequence with an embedding corresponding to each index, and then masking one or more of embeddings;
determining a predicted index sequence that reconstructs a masked embedding based on a masked embedding sequence; and
determining an evaluation score based on a difference between the centroid index sequence and the predicted index sequence.

12. The apparatus of claim 11, wherein the latent representation is extracted using a machine learning model that has pre-trained referenced speech using a self-supervised learning method.

13. The apparatus of claim 11, wherein clustering uses a k-means clustering algorithm.

14. The apparatus of claim 11, wherein masking is performed by randomly selecting one embedding from the embedding sequences and replacing five consecutive embeddings starting from the selected embedding with the one embedding.

15. The apparatus of claim 11, wherein the predicted index sequence is estimated using a machine learning model that has pre-trained a feature distribution of referenced speech using an unsupervised learning method.

16. The apparatus of claim 11, wherein determining the evaluation score comprises determining a loss value between the centroid index sequence and the predicted index sequence using a cross-entropy loss function.

17. The apparatus of claim 11, wherein the operations further comprises determining an integrated score that evaluates multidimensional speech quality by integrating a plurality of evaluation scores determined based on latent representations corresponding to different acoustic features.

18. The apparatus of claim 11, wherein determining the latent representation corresponding to each frame comprises extracting acoustic information from a sixth layer and linguistic information from a twenty-third layer of a transformer encoder.

19. The apparatus of claim 11, wherein clustering each latent representation comprises discretizing the latent representation into 1024 clusters.

20. An apparatus comprising:
one or more processors; and
at least one memory storing a program including program instructions that, when executed by the one or more processors, cause the one or more processors to perform operations comprising:
receiving referenced speech including one or more frames;
determining a latent representation corresponding to each frame;
clustering each latent representation, and then mapping a center point of each cluster to an index to determine a centroid index sequence;
determining an embedding sequence by replacing each index of the centroid index sequence with an embedding corresponding to each index, and then masking one or more of the embeddings;
determining a predicted index sequence that reconstructs a masked embedding based on a masked embedding sequence, using a machine learning model that has pre-trained a feature distribution of the referenced speech using an unsupervised learning method;
determining a loss value between the centroid index sequence and the predicted index sequence; and
updating a parameter of the machine learning model based on the loss value.
